(19) United States
(12) Patent Application Publication
(10) Pub. No.: US 2005/0201080 A1
(43) Pub. Date: Sep. 15, 2005

(54) Seating apparatus having an illuminated panel

(76) Inventor: Jimmy Seward, Toledo, OH (US)

Correspondence Address: Douglas L. Wathen;Gifford, Krass, Groh, Sprinkle,, Anderson & Citkowski, P.C., P.O. Box 7021, Troy, MI, 48007-7021, US

(21) Appl. No.: 11/078,844

(22) Filed: Mar. 11, 2005

Related U.S. Application Data
(60) Provisional application No. 60/552,611, filed on Mar. 12, 2004.

(51) Int. Cl. F21V 33/00

(52) U.S. Cl. 362/97; 362/812; 362/16; 362/33; 362/227; 362/276; 362/245; 362/251

(57) ABSTRACT

A display panel is provided, including a light source, a power source, a switch, a display film and a display housing. The power source provides power to the light source through the switch, such that operating the switch energizes the light source. The display film provides a visual image when illuminated by the light source. The display housing contains the light source the display film and the switch, and the housing is adapted to attach to a curved surface.

### REFERENCE TO RELATED APPLICATION

This application claims priority from U.S. Provisional Patent Application Ser. No. 60/552,611, filed Mar. 12, 2004, the entire content of which is incorporated herein by reference.

### FIELD OF THE INVENTION

The invention relates to a display, in particular to an illuminated display that can be attached to a seat.

### BACKGROUND OF THE INVENTION

Public spaces, such as restaurants, bars, and retail locations, are excellent locations for advertising. Conventional signs, such as printed display ads, can be used. However, these low-technology advertising methods often fail to get the attention of the public. Conventional video displays, such as televisions, are sometimes used. However, these units are often expensive, fragile, and not particularly versatile. Temporary deployment of such displays is difficult.

Hence, there is a need for an advertising medium that has a high-technology appearance, so as to attract attention, and is also robust enough to be used in a public space, and cheap enough that occasional damage to a unit is not a serious problem.

Liquid crystal displays have been mounted in the backs of reclining seats, for example airline seats. U.S. Pat. No. 4,788,588 to Hideo describes a liquid crystal display apparatus where the visual angle of the panel relative to a viewer is used to control a voltage, so that the quality of the image displayed by the panel is not degraded even if the screen visual angle is changed. U.S. Pat. No. 5,507,556 to Dixon describes a pivot mechanism by which a display can be adjusted for a better view. U.K. Pat. App. GB2282691A, Pritchard describes a vehicle seat display panel that mounts under, for example, the seat of a taxi. However, the prior art fails to disclose a display system in part conformable to a curved seat surface.

### SUMMARY OF THE INVENTION

The present invention provides an apparatus and method for addressing the shortcomings of the prior art. According to one embodiment, a display panel is provided, including a light source, a power source, a switch, a display film and a display housing. The power source provides power to the light source through the switch, such that operating the switch energizes the light source. The display film provides a visual image when illuminated by the light source. The display housing contains the light source the display film and the switch, and the housing is adapted to attach to a curved surface.

### BRIEF DESCRIPTION OF THE DRAWINGS

FIG. 1 is a perspective view of a seat according to the present invention;

FIG. 2 is a perspective view of an alternate embodiment of a seat according to the present invention;

FIG. 3 is a perspective view of the underside of a seat bottom illustrating the seat support and seat pan assembly;

FIG. 4 is a cross-sectional view through line 4-4 of the seat and display panel of the present invention;

FIG. 5 illustrates a system having a plurality of display panels and a main control unit;

FIG. 6 illustrates a main control unit; and

FIGS. 7-14 illustrate various examples of display panels.

### DETAILED DESCRIPTION OF THE INVENTION

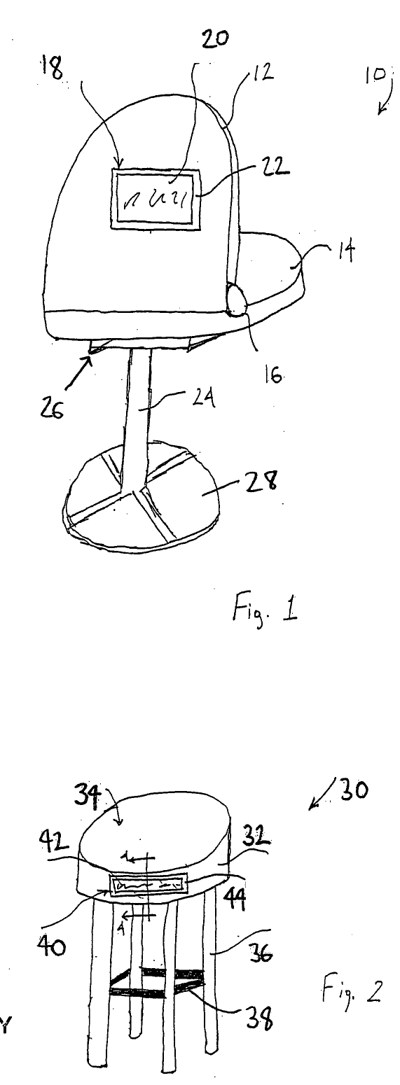

FIG. 1 illustrates a seat assembly indicated generally at 10. The seat assembly 10 includes a seatback frame and a seat bottom frame, the frames supporting cushion assemblies for supporting an occupant, thereby forming a seatback 12 and a seat bottom 14. The seatback frame is pivotally connected to the seat bottom frame through a recliner mechanism 16. Display panel 18 is located on the seatback 12. The display panel 18 includes a display housing 22 that frames the display area 20. The seat assembly also has a leg assembly 24 and a base 28. Under-seat frame 26 can be used to support associated electronic devices or drivers, other electronic circuitry, power supply, seat occupancy sensor, or other components.

In other examples, the display panel could be located anywhere on the seatback 12, or comprise the entire seatback. The display panel could also be positioned on the seat bottom.

The display housing can be made of metal, plastic, or any other suitable material. The display housing can be recessed into the seatback so that the display area is flush with the outer surface of the seatback.

The display area can comprises a static display, LCD screen, computer display, photograph, LED lights, stickers, poster-board, or any other type of visual presentation medium. In a preferred embodiment, the display comprises a translucent material, such a thin plastic sheet, transparency or film.

The seatback frame and the seat bottom frame can be adapted to receive different types of components such as by including multiple locating and mounting structures, such as holes and bosses. The seatback frame and the seat bottom frame can be adapted to receive other components, such as a plurality of legs, wheels, occupant detection systems, and adjustable lumbar support mechanisms.

The back frame can include a pair of generally vertical side members, generally elongated and having an upper end and a lower end. The back frame can further include an elongated, generally horizontally extending upper cross member that is attached to the upper ends of the side members. The upper cross member can be straight or curved or have any desired shape as required by the particular seat aesthetics. The seat can also include a generally lower cross member which extends between the lower ends of the side members. The side members, the upper cross member, and the lower cross member form a generally rectangular frame having four attached corners for supporting a cushion and trim assembly for supporting the back of an occupant.

The back frame and the bottom frame can optionally be attached to one another directly. The seat assembly can be adapted to be used as an interior seat, such as used in restaurants or other businesses, or can be used as a vehicle seat, such as in a taxi cab. The recliner mechanism can be any conventional recliner mechanism, such as manually or electrically operated, which selectively permits the seatback to pivot relative to the seat bottom. It should be understood that any type of seat configuration suitable for supporting an occupant could be used.

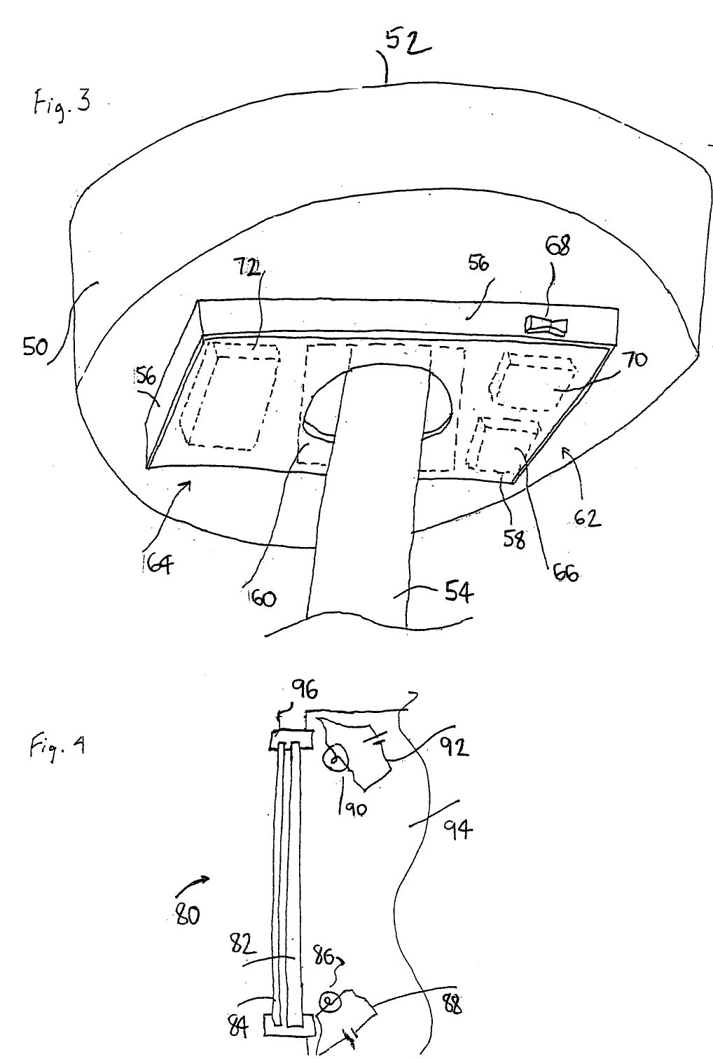

FIG. 2 illustrates a back-less seat 30, having a seat bottom 32 comprising a seat bottom frame supporting a cushion assembly, providing a seating surface 34. The seat further includes legs such as 36, cross-members such as 38, and display panel 40 including a display area 42 and display housing 44.

In a back-less seat (or stool), the seat frame typically comprises a generally square or circular component. The cushion, having the same general shape as the frame, is then positioned on the frame. A cover could then be positioned over the frame and cushion and attached thereto.

The display panel can be located anywhere on the seat bottom. The display panel can be located on the sides of the seat bottom, or positioned on the seating surface of the seat bottom. The display panel 36 can be recessed into the seat bottom so that the display area is flush with the outer surface of the seat, or can be otherwise attached to the seat bottom, for example through use of a flexible display area and flexible housing, as discussed in more detail below.

The side members, the upper cross member, and the lower cross member can be formed from wood, aluminum or steel. The members forming the seatback frame can have any suitable number and shapes of ridges and apertures for added strength and reduced weight. The seatback frame members can also be formed from tubular steel members or any other suitable material. Additionally, the seat frame could include cross or vertical members positioned elsewhere on the frame for support or shaping of the seatback and seat bottom. The seat bottom can be similarly formed.

FIG. 3 illustrates an under-seat structure, including seat bottom 50 providing a seating surface 52, seat support (leg) 54, mounting flanges such as flange 56, seat pan 58, the flanges 56 and the seat pan 58 defining a generally rectangular box 62 with one side of the box remaining open (the non-flange side 64), support plate 60, seat occupancy sensor 66, control switch 68, programmable computer device 70, and power-supply unit 72.

The mounting flange is connected to the seat bottom, and the seat pan is connected to the flanges. In this example, two flanges are used to connect the seat pan to the seat bottom. The flanges can be on opposed sides of the seat pan or on all sides of the seat, or have any other suitable configuration. The flanges can be sized such that the flange allows the seat pan to be spaced away from the seat bottom. The space between the seat pan and seat bottom thereby defines a gap. The seat pan can be formed to cover the entire support plate, leaving space for the seat support, or can only cover a portion of the seat bottom. The flange can be mounted around the entire seat bottom, encircling the support plate.

Optionally, the flange extends about at least three sides of the seat with the seat pan extending between two opposed flanges and connected to a third flange. In this configuration, the flanges and seat pan define a generally rectangular box with one side of the box remaining open (the non-flange side). The box, formed by the flanges and the seat pan, is adapted to receive electrical circuitry or a power supply in accordance with the present invention.

The display is operatively connected to the power switch, so that a user can turn the display on and off. A seat sensor mechanism can also be positioned within the seat that automatically detects when the seat is occupied. Thus, the display can activate only when the seat is occupied, as detected by the seat sensor.

The seat bottom can be part of a barstool (with or without a seatback). The seat support is connected to the support plate, the support plate being connected with the seat bottom frame. The support plate could include an apparatus (not shown), positioned between the seat bottom and the support plate, that allows that seat to swivel about a vertical axis.

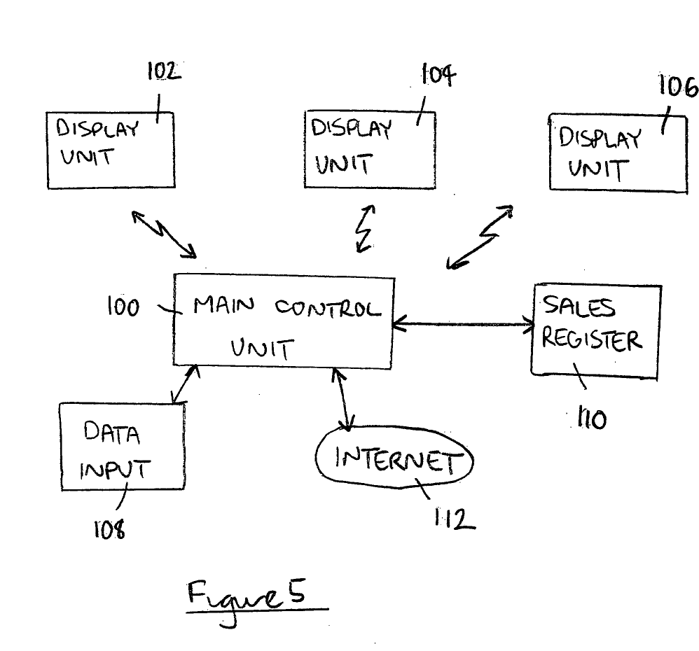

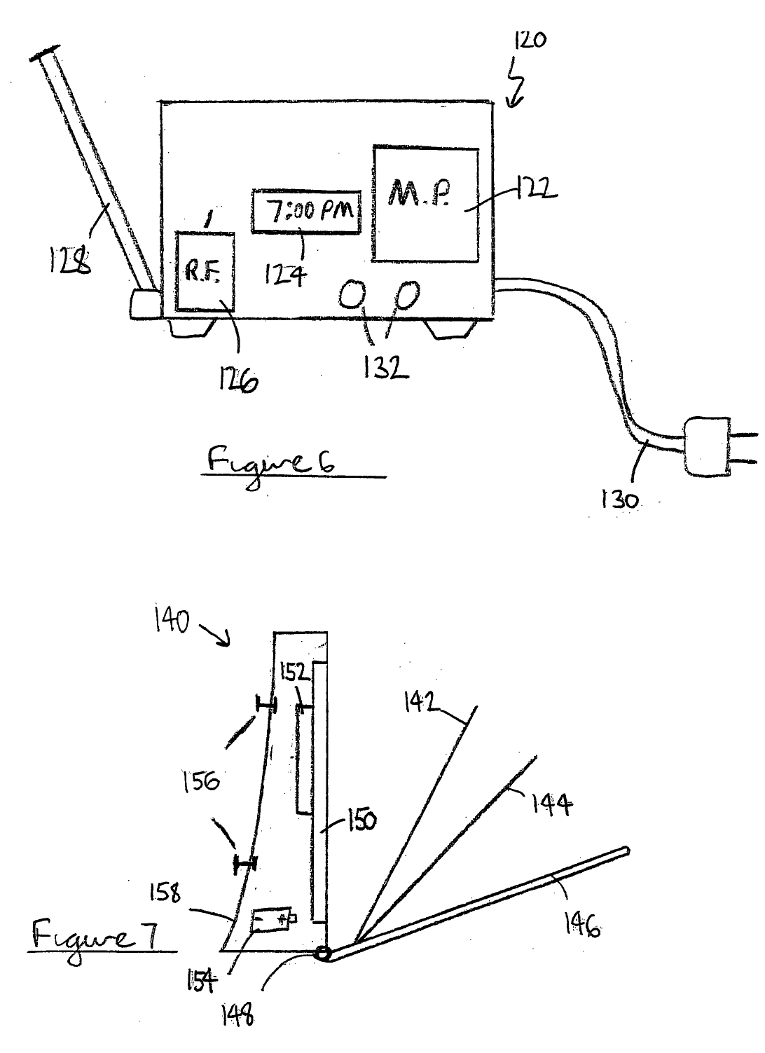

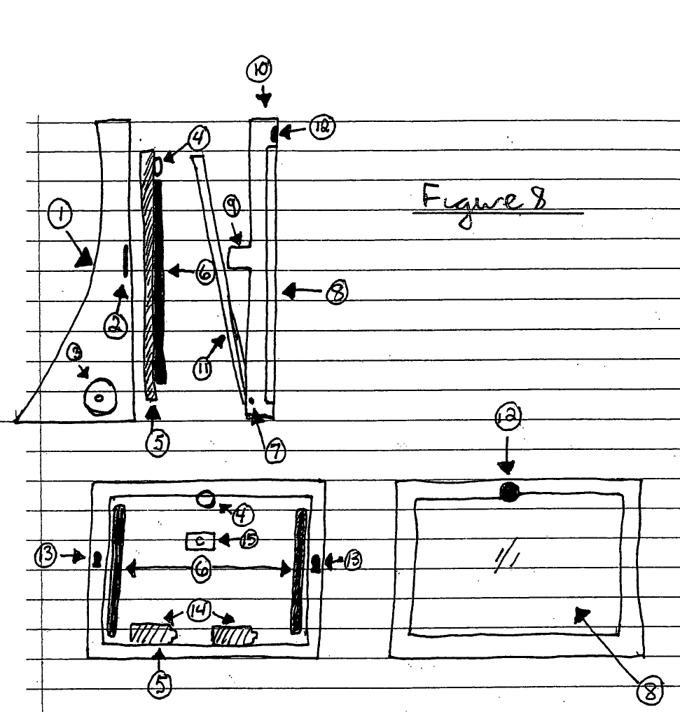

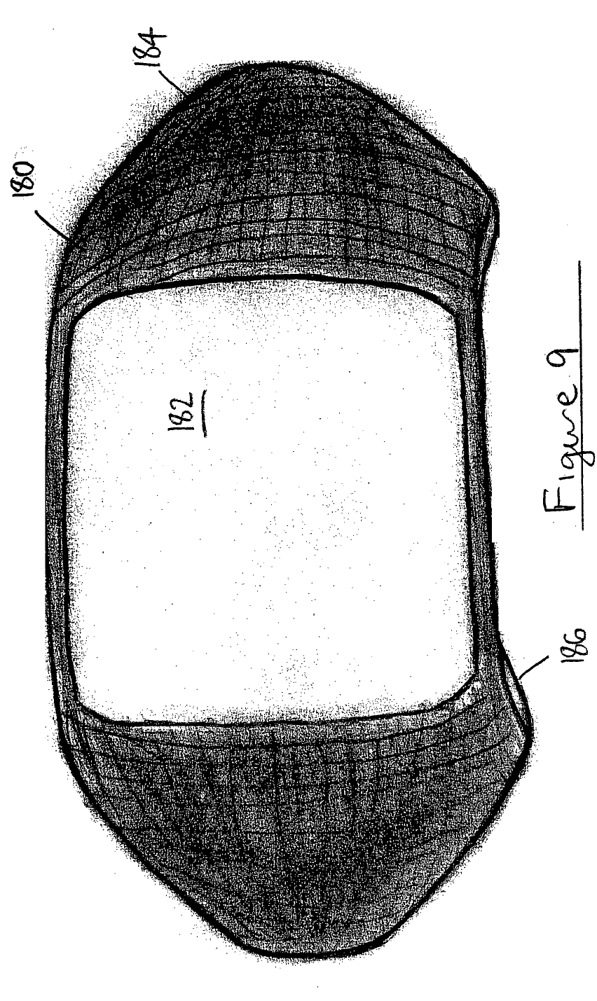

FIG. 4 illustrates a cross sectional view through one example of a display panel, illustrated generally at 80. The display panel includes display film 82, protective cover 84, first lamp 86, first power supply 88, second lamp 90, second power supply 92, and part of the display housing 96 The volume 94 is contained within the display housing, and may further include diffusers, reflectors, or other optical components.

In other examples, the lights can be contained within a portion of the seat, the display panel attaching to the seat so as to provide an illuminated display area.

The lamps can be incandescent light bulbs, such as Christmas tree lights, fiber optic light sources, light emitting diodes (LEDs) or other light sources. The lamps can be positioned as illustrated, at positions along the length and width of the display area, between the protective cover and the display film, or at any other suitable location(s). Thus, the display film can be front-lit.

The wiring for the lamps can be connected to an external power-supply unit, or a power unit positioned within (or supported by) the seat to which the panel is attached. Additionally, the lamps could be connected with a seat occupancy sensor so that the lamps only activate when the seat is occupied. Display panels described here can be used with any form of seat.

The display film can be a translucent film, such as a transparent sheet having an image printed thereon. The protective cover can be a transparent sheet or screen in order to protect the display area. When the lamp is activated, the image is back-lit. The display film can be removed and replaced as required. The display film can be, for example, a liquid crystal display, LED display, organic LED display, or other electronically programmable display material. The display film can be light emitting, so that lamps are not required.

The display panel can be provided with controls, (such as an on/off switch, date entry mechanism such as a keypad), power supply (such as a battery), microchips (for example as part of a display drive circuit), and wiring for illuminating and controlling the display. The display panel can also be in electrical communications with external controls and circuitry which can be located within or attached to another part of the chair. The box formed by the flange and seat pan, as discussed above in relation to FIG. 3, can be used for this purpose. Such a configuration allows the seat to be used without the controls and accessories interfering with the seat.

For example, an under-seat mechanical support or frame, such as the box described above, can contain a battery, control switches, wiring, and/or a programmable computer device or microchip which controls and operates the display. The wiring can be routed through the internal seat structure in order to conceal it. One end of the wiring can be connected to an illumination apparatus, such as lamps, for a display panel. The illumination could include at least one lamp, fiber optic lights, or any other lighting mechanism. Using an electronic display, such as an LCD display, LED display, or other display, the wiring can be operatively connected to the electronic circuitry of the system, such as a display driver. The other end of the wiring can be connected to a power source. The power source can be a battery, such as a single-use battery, or a rechargeable battery. If a rechargeable battery is used, an adapter can be provided such that the rechargeable battery can be connected to another power source (A/C) to be charged.

In other examples, any or all of the components for operating the display can be incorporated into a seatback, or other part of a chair such as within a tubular frame member, base, arm-rest, or seat support. The display panel, associated controls, and other components can optionally be a self-contained apparatus that is connected to the seatback without having to make any modifications to the seat bottom, optional seat pan, or other part of the chair.

FIG. 5 shows a system including a main control unit 100, display panels 102, 104, and 106, data input 108, sales register 110, and connection to the Internet 112. The main control unit is in communication with the display panels, through wireless communications links shown by jagged arrows. The main control unit can be used to perform the following functions: synchronization of the visual presentations shown on the display panels, synchronization of display panel illumination, sequential illumination or other time dependent illuminations of display panels, control of the visuals shown on the display panels, or to otherwise modify the information provided by display panels.

Data can be received from the Internet, for example new visual data to be presented on the display panels. Sales data can be correlated with visual display programs, and used to determine the effectiveness of the displays in promoting sales (if appropriate). Promotions, announced by the display panels, can be provided automatically by the sales register.

FIG. 6 illustrates a main control unit at 120, including a microprocessor 122, clock 124, radio-frequency transceiver 126, antenna 128, power cable 130, and programming controls 132.

A user can operate the programming controls so as to select a particular visual display presented by the display panels, data being communicated wirelessly by the antenna to the display panels. A user can select between various illumination patterns and time-dependent illumination sequences, visual presentations shown on the display panels (if these are changeable), or other operating parameters.

FIG. 7 illustrates one example of a display panel 140, having hinged light diffuser 142, transparency printed advertising material 144, cover plate 146 (providing a viewing window), hinge 148, mirrored light diffuser with LED/pipe light 160, circuit board 152 (including a microprocessor or other smart chip, clock, and radio-frequency receiver and antenna), battery 154, mounting flanges 156, and molded display housing having a rear surface 158 curved to match the curved outer surface of a seat back, seat bottom, or other chair part.

The curved rear surface makes it possible to mount the display panel on a seat without having to modify the seat (for example by cutting). Also, the curved rear surface improves the appearance of the display panel on the seat, and can help eliminate protruding edges that can catch on passers-by.

In one example, the rear surface of the display housing has a horizontal radius matching the horizontal curvature of a seat back, and a vertical profile that allows the rear of the display housing to be placed against the seat back while allowing the display area to be vertical or to tilt upwards. If the rear surface of the display housing was flat and parallel to the display area, as in a conventional display, the display area would usually tend to tilt downwards, as chair backs often slope backwards.

The hinged diffuser and cover plate allows transparencies to be used as the display film. Other mechanisms can be used to support transparencies, such as slots into which transparencies can be slid, pull-out components, and various mechanisms well known to an engineer of average skill.

FIG. 8 illustrates another example of a display panel. The component numbers used in this figure refer only to FIG. 8, and in the text below will be prefixed with “8-”. The display panel has a display housing 8-1 having a radius matching the outer surface of a seat part, keyholed opening 8-2 that allows a front panel to be slid in and pushed downwards to lock in position, battery 8-3, motion activated sensor 8-4, a circuit board 8-5, light tubes such as 8-6, each light tube having a white LED in one or both ends, a hidden hinge 8-7 that helps attach a diffuser (8-11) to the front cover, a clear window 8-8, an attachment pole 8-9, a front cover or lid 8-10, diffuser 8-11, the diffuser being able to trap a transparency or other display film between it and the window to produce a uniformly illuminated visual presentation on the display, hole 8-12 for mounting a motion sensor, key-hole 8-13 for the front cover, power source 8-14, and microprocessor 8-15.

The microprocessor controls the illumination of the transparency, for example providing sequential illumination periods. The microprocessor can cause the LEDs to light in a predetermined time-dependent sequence (for example flashing on and off), to illuminate for a fixed period on receipt of a signal from a motion sensor, on some other time-controlled sequence, on a random sequence, or in response to another signal.

FIG. 9 illustrates part of a display housing 180, having an opening 182 that can frame a display area, curved side portions 184, and a curved back 186. This design provides great practical and functional advantages over a conventional box shaped display housing, for the applications discussed in this specification and for other applications where a display is mounted on a curved surface.

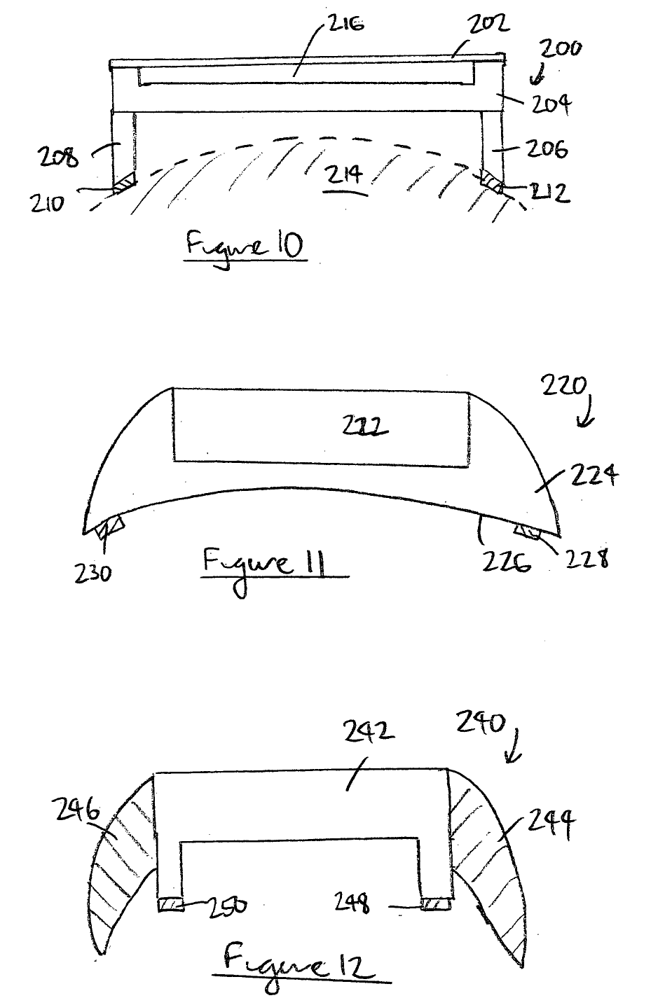

FIG. 10 shows a display panel 200 in cross-section, for example as seen looking downwards, having a front cover 202, main display housing 204 containing illumination controls and light sources, the space 216 being used to support a display film, and protrusions 206 and 208, separated by approximately the width of the display housing, which attach to a seat back 214 using adhesive pads 210 and 212.

The protrusions can be vertical ribs on the rear of the display housing. In this context, the rear of the display housing is the portion in closest proximity to the seat back 214. The curvature of the seat back is accommodated by the space between the ribs.

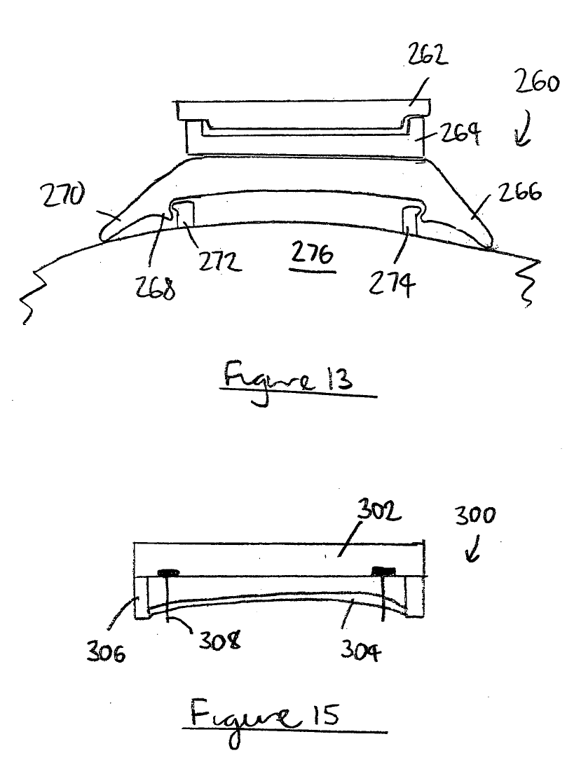

FIG. 11 shows another example of a display panel 220 in which display electronics and the display area are contained by electronics case 222 (details not shown), the display case fitting into a recess in a curved display housing 224. In this case, the display housing can be of a plastic, molded, rubbery and/or resilient material. Attachment mechanisms 228 and 230 can be used to attach the display housing to the seat. The housing has a curved back 226, and may further deform on attachment, particularly at the outer edges, to match the radius of the seat.

FIG. 12 shows another example of a display panel 240, where the housing has a rigid part 242 containing the display film, lamps, and other electronic components, attachment mechanisms 248 and 250 on rearward facing ribs or spurs, and flexible wings 244 and 246 that conform to the curvature of the seat, for example by being pushed outwards against a natural resiliency, so as to present a smooth exterior.

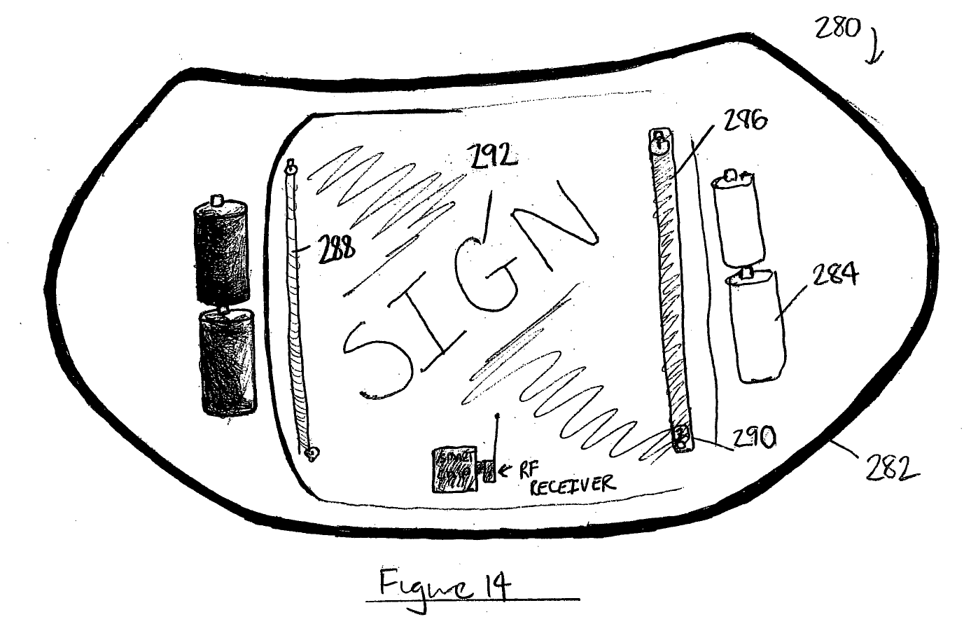

FIG. 13 shows a display panel 260 having cover 262 (including display film), and a display housing including an electronics case 264 (including electronics, battery, and lighting), and a display panel housing 266, the housing having a curved rear surface (facing the seat 276) conforming with the curvature of the seat, and having an attachment mechanism (in this case, hooks such as 268) that attach to hardware (posts 272 and 274) connected to the chair by any convenient mechanism.

FIG. 14 illustrates a display panel 280, having a display housing having a curved periphery 282, batteries such as battery 284 contained within the housing, light pipes 286 and 288 having white LEDs such as 290 at each end of the light pipe, and a visual presentation 292 displayed within the display area, the visual presentation determined by a display film contained within the housing. Unless the housing is (optionally) transparent or translucent, the batteries and light pipes may not be visible to a person looking at the visual presentation.

FIG. 15 illustrates a display panel, shown generally at 300, having a display housing 302 having rearward protruding spurs 306 that contact a seat back when the display panel is placed against the seat back, deformable sheet 304 that conforms to the seat back and provides stability, and fasteners 308 that attach the display panel to the seat back.

### OTHER ALTERNATIVES

Light Sources

Illumination can be provided by light emitting diodes, incandescent lamps, light-emitting materials such as polymers, other organic light emitting materials, ambient lighting, directed ambient lighting (such as provided by spotlights, lasers, and the like), light collected from the environment and concentrated by an optical system, or other source.

In one example, the display film is a colored transparency, and the light source is a white backlight. The light source can also include colored lights, such as red, green, blue, yellow, orange, and/or UV lamps, such as light emitting diodes. A black and white, or other limited color, display film can be illuminated sequentially or in another pattern by colored lamps.

Power Source

The power source for the backlight, other lighting source, light emitting display material, circuitry, and/or other associated device can be provided by one or more batteries (such as rechargeable batteries), photocells, generator built into the seat and powered by rotation or other motion, or other source. A power source can be included in the seat, and be electrically connected to an attached display panel.

Battery life can be extended by periodic energizing of lamps or other light sources, for example at random, predetermined, or periodic intervals, in response to motion, only at times customers are expected to be present (such as store opening hours), or other method.

Display Films

The term display film, as used here, describes the image providing device. For example, the display film can be a colored image printed on a transparent sheet, a liquid crystal display, an LED display, other electronic display, reflective display, or other display.

In another example, the seat back provides a screen for a remote projection display, such as provided by a liquid crystal projector or scanning laser system.

The display film may be in the form of a sheet or roll that is scrolled through the display area so as to provide a changing display.

A plastic liquid crystal display can be provided that is curved slightly within a flexible housing when the housing is attached to a curved surface.

If the display film is a liquid crystal display or other electronic display, cushioning can be provided to prevent shock damage. For example, the display can be mounted on flexible mounts within the display housing.

Attachment of Display Panel to Seat

Display panels can be attached to seats using brackets, screws, nails, engagement of matching structures (e.g. using keyhole slots in the display panel to engage protruding hardware from the seat), hook-and-loop systems such as VELCRO, adhesives (such as releasable adhesive), suction cups and related devices, hooks (for example that hook around seat parts), straps, tapes, and other attachment mechanisms.

System Configurations

Multiple display panels can be attached to seats within e.g. a business, and controlled by electronic signals provided over a local wireless network. For example, light sources can be activated in controlled time-dependent sequences under computer control. The control signals can be provided by a main control unit, a display panel including the function of a main control unit, using data received over the Internet, or using data received from a local electronic device, such as a cell-phone or personal computer.

Displayed data can coordinate with other activities within the business, for example television or movie displays, signals provided by local video cameras, sales promotions, events such as the start of a show, and signals provided by electronic devices carried by customers. For example, a seat-back display may show the name and drink preference of the occupant.

Other Display Panel Functionality

The display panel may also include built in speakers, vibrating mechanisms, and the like. Audio commentary may accompany displayed images. Advertising material displayed visually can be accompanied by an audible background.

Displayed Information

Information displayed on the displayed panels can be of any type, for example text, graphics, video, or other information. Examples include advertising materials, notice of sales promotion, the weight of the person seated in the seat (for example as provided by a weight sensor in communication with the display panel), other information related to the seated person (for example as entered into the display panel using a data input mechanism, or communicated from a device carried by the person, or communicated from a main control unit, Internet, or other source), sports scores, prices (e.g. of food, drink, or other services), information related to the seat status (such as “reserved”, or seat number or class, or other information. Information may be provided by sensors on the seated person's body, such as medical signals such as an EKG, which would be useful in a medical or assisted living facility.

The seat back may be clear or otherwise visually transmissive, so that information may be transmitted through to the front of the seat.

Display panels according to embodiments of the present invention can be used with any seating structure. Examples discussed are not intended to be limiting, but illustrative. Other examples according to the present invention will be clear to those skilled in the relevant arts. The invention may be practiced otherwise than as specifically explained and illustrated without departing from its spirit or scope.

1. A display panel, the display panel comprising:
a light source;
a power source;
a switch, the power source providing power to the light source through the switch, the switch being operable to energize the light source when the switch is actuated;
a display film, providing a visual image when illuminated by the light source; and
a display housing, containing the light source, the display film, and the switch, the display housing being adapted to attach to a curved surface.

2. The display panel of claim 1, further including an electronic circuit operable to actuate the switch at intervals.

3. The display panel of claim 1, further including an electronic circuit operable to actuate the switch in response to a signal from a motion sensor.

4. The display panel of claim 1, further including an electronic circuit operable to actuate the switch in response to a signal from a seat occupancy sensor.

5. The display panel of claim 1, further including an electronic circuit operable to actuate the switch in response to a wireless signal.

6. The display panel of claim 1, wherein the display housing includes a flexible portion that conforms to the curved surface when the display housing is attached to the curved surface.

7. A method of providing advertising material to patrons of an establishment, the method comprising:
attaching a display panel to the seat back of each of at least one seat within the establishment; and
modifying the visual presentation provided by the display using a wireless transmission.

8. The method of claim 7, wherein the visual display of the display panel is modified by energizing a lamp within the display panel.

9. The method of claim 7, wherein the visual presentation is determined by a colored image on a sheet within the display panel.
